(19) United States
(12) Patent Application Publication
(10) Pub. No.: US 2018/0146651 A1
(43) Pub. Date: May 31, 2018

(54) Heated Fishing Rod System

(71) Applicant: Richard Leiberg, Sturgeon Bay, WI (US)

(72) Inventor: Richard Leiberg, Sturgeon Bay, WI (US)

(21) Appl. No.: 15/364,696

(22) Filed: Nov. 30, 2016

(51) Int. Cl. A01K 87/08

(52) U.S. Cl. CPC A01K 87/085

(57) ABSTRACT

A heated fishing rod system includes a fishing rod that has a handle and a reel mount. A heating unit is coupled to the fishing rod. The heating unit is in thermal communication with the handle such that the heating unit heats the handle when the heating unit is turned on. In this way the heating unit inhibits hands from getting cold when the fishing rod is manipulated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to heating devices and more particularly pertains to a new heating device for heating a handle of a fishing rod.

### BRIEF SUMMARY OF THE INVENTION

An embodiment of the disclosure meets the needs presented above by generally comprising a fishing rod that has a handle and a reel mount. A heating unit is coupled to the fishing rod. The heating unit is in thermal communication with the handle such that the heating unit heats the handle when the heating unit is turned on. In this way the heating unit inhibits hands from getting cold when the fishing rod is manipulated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a heated fishing rod system according to an embodiment of the disclosure.

FIG. 2 is a right side phantom view of an embodiment of the disclosure.

FIG. 3 is a cross sectional view taken along line 3-3 of FIG. 2 of an embodiment of the disclosure.

FIG. 4 is a cross sectional view taken along line 4-4 of FIG. 3 of an embodiment of the disclosure.

### DETAILED DESCRIPTION OF THE INVENTION

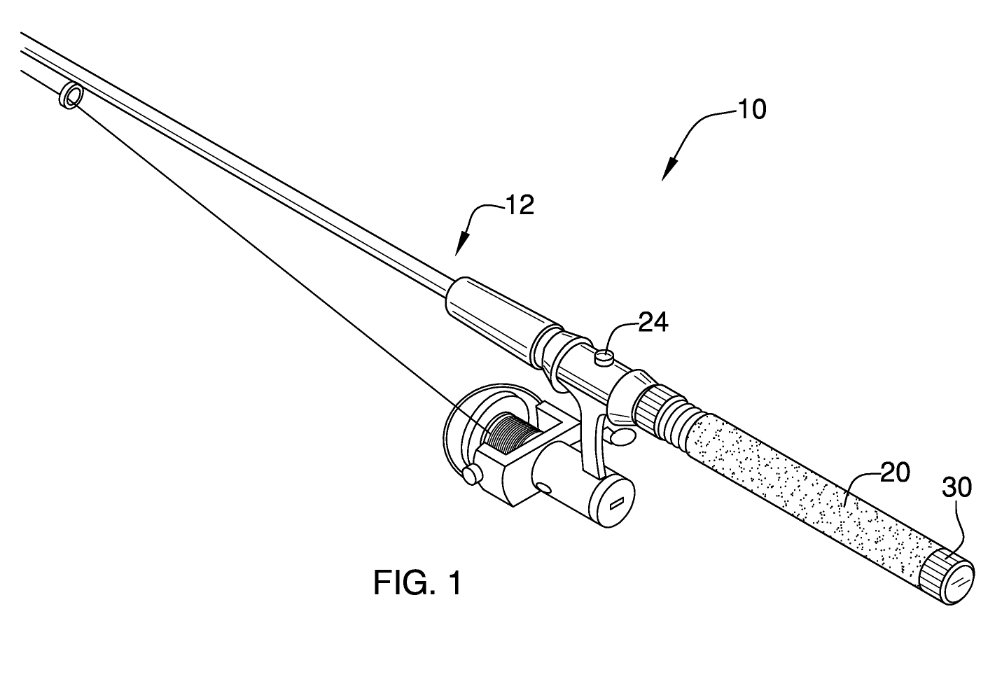

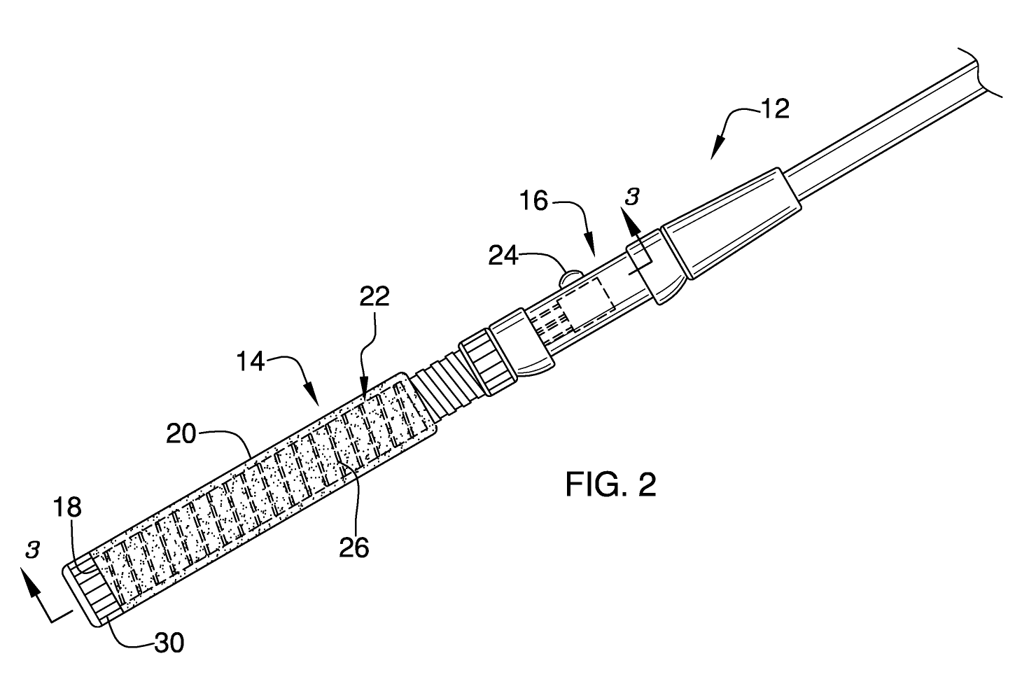

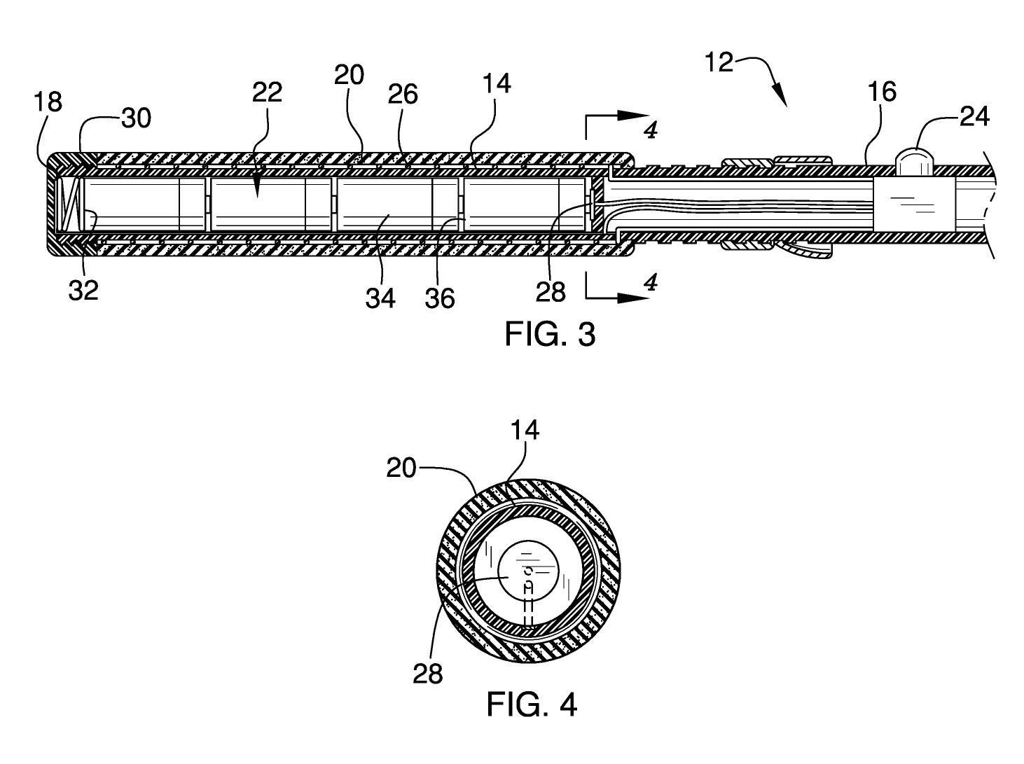

With reference now to the drawings, and in particular to FIGS. 1 through 4 thereof, a new heating device embodying the principles and concepts of an embodiment of the disclosure and generally designated by the reference numeral 10 will be described.

As best illustrated in FIGS. 1 through 4, the heated fishing rod system 10 generally comprises a fishing rod 12 that has a handle 14 and a reel mount 16. The handle 14 has a distal end 18 with respect to the reel mount 16 and the distal end 18 is open. The fishing rod 12 may be an ice fishing rod 12, a full size fishing rod 12 or any other fishing rod 12. Moreover, the fishing rod 12 may be comprised of fiberglass, wood or any other fishing rod 12 material. A grip 20 is positioned around the handle 14 to enhance grip 20 ping the handle 14 and the grip 20 is comprised of a thermally conductive material.

A heating unit 22 is provided and the heating unit 22 is coupled to the fishing rod 12. The heating unit 22 is in thermal communication with the handle 14 such that the heating unit 22 heats the handle 14 when the heating unit 22 is turned on. In this way the heating unit 22 inhibits hands from getting cold when the fishing rod 12 is manipulated.

The heating unit 22 comprises a button 24 that is coupled to the fishing rod 12 and the button 24 may be manipulated. The button 24 may be positioned on the reel mount 16. A heating coil 26 is wrapped around the handle 14. The heating coil 26 is positioned between the handle 14 and the grip 20 such that the heating coil 26 is in thermal communication with the grip 20. The heating coil 26 extends between the reel mount 16 and the distal end 18 and the heating coil 26 heats the grip 20 when the heating coil 26 is turned on. The heating coil 26 may be an electric heating coil 26 with an operational temperature ranging between approximately 80 degrees Fahrenheit and 100 degrees Fahrenheit.

A first contact 28 is positioned within the handle 14 and the first contact 28 is electrically coupled to the button 24. A cap 30 is removably coupled to the handle 14 and the cap 30 is positioned on the distal end 18 of the handle 14. The cap 30 may threadably engage the handle 14 or the like thereby retaining the cap 30 on the handle 14. A second contact 32 is coupled to the cap 30 such that the contact is positioned within the handle 14 when the cap 30 is positioned on the distal end 18.

A power supply 34 is positioned within the handle 14 and the power supply 34 is electrically coupled to the button 24. The power supply 34 comprises at least one battery 36. The at least one battery 36 is electrically coupled between the first contact 28 and the second contact 32 when the cap 30 is positioned on the handle 14.

In use, the button 24 is manipulated to turn the heating coil 26 on. The heating coil 26 heats the grip 20 and the grip 20 transfers heat from the heating coil 26 to a user's hands when the grip 20 is grip 20 ped. In this way the heating coil 26 keeps the user's hands warm when the user is grip 20 ping the handle 14. The cap 30 is removed and the at least one battery 36 is changed when the at least one battery 36 is dead.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated fishing rod system comprising:
a fishing rod having a handle and a reel mount; and
a heating unit being coupled to said fishing rod, said heating unit being in thermal communication with said handle such that said heating unit heats said handle when said heating unit is turned on wherein said heating unit is configured to inhibit hands from getting cold when said fishing rod is manipulated.

2. The system according to claim 1, wherein said handle has a distal end with respect to said reel mount, said distal end being open.

3. The system according to claim 1, further comprising a grip being positioned around said handle wherein said grips is configured to enhance gripping said handle.

4. The system according to claim 1, wherein said heating unit comprises a button being coupled to said fishing rod wherein said button is configured to be manipulated.

5. The system according to claim 4, further comprising:
said handle having a distal end with respect to said reel mount, said distal end being open; and
a heating coil being positioned between said handle and said grip such that said heating coil is in thermal communication with said grip, said heating coil extending between said reel mount and said distal end, said heating coil heating said grip when said heating coil is turned on.

6. The system according to claim 4, further comprising a first contact being positioned within said handle, said first contact being electrically coupled to said button.

7. The system according to claim 2, further comprising a cap being removably coupled to said handle, said cap being positioned on said distal end of said handle.

8. The system according to claim 7, further comprising a second contact being coupled to said cap such that said contact is positioned within said handle when said cap is positioned on said distal end.

9. The system according to claim 4, further comprising:
a first contact;
a cap;
a second contact being coupled to said cap; and
a power supply being positioned within said handle, said power supply being electrically coupled to said button, said power supply comprising at least one battery, said at least one battery being electrically coupled between said first contact and said second contact when said cap is positioned on said handle.

10. A heated fishing rod system comprising:
a fishing rod having a handle and a reel mount, said handle having a distal end with respect to said reel mount, said distal end being open;
a grip being positioned around said handle wherein said grips is configured to enhance gripping said handle; and
a heating unit being coupled to said fishing rod, said heating unit being in thermal communication with said handle such that said heating unit heats said handle when said heating unit is turned on wherein said heating unit is configured to inhibit hands from getting cold when said fishing rod is manipulated, said heating unit comprising:
a button being coupled to said fishing rod wherein said button is configured to be manipulated,
a heating coil being positioned between said handle and said grip such that said heating coil is in thermal communication with said grip, said heating coil extending between said reel mount and said distal end, said heating coil heating said grip when said heating coil is turned on,
a first contact being positioned within said handle, said first contact being electrically coupled to said button,
a cap being removably coupled to said handle, said cap being positioned on said distal end of said handle,
a second contact being coupled to said cap such that said contact is positioned within said handle when said cap is positioned on said distal end, and
a power supply being positioned within said handle, said power supply being electrically coupled to said button, said power supply comprising at least one battery, said at least one battery being electrically coupled between said first contact and said second contact when said cap is positioned on said handle.
